(19) United States
(12) Patent Application Publication
(10) Pub. No.: US 2022/0244287 A1
(43) Pub. Date: Aug. 4, 2022

(54) Arrangement Having a Measuring Apparatus for a Scanning Probe Microscope, Scanning Probe Microscope, and Method for Operating

(71) Applicant: Bruker Nano GmbH, Berlin (DE)

(72) Inventors: Torsten Jahnke, Berlin (DE); Frederik Büchau-Vender, Berlin (DE); Marian Schücker, Rangsdorf (DE)

(21) Appl. No.: 17/620,375

(22) PCT Filed: Jun. 18, 2020
(86) PCT No.: PCT/DE2020/100516

§ 371 Date: Dec. 17, 2021

(30) Foreign Application Priority Data
Jun. 18, 2019 (DE) 10 2019 116 472.9
Dec. 18, 2019 (DE) 10 2019 134 993.1

(51) Int. Cl. G01Q 10/04; G01Q 70/04

(52) U.S. Cl. CPC G01Q 10/045; G01Q 70/04

(57) ABSTRACT

The invention relates to an arrangement having a measuring apparatus for a scanning probe microscope, comprising: a sample receptacle, which is designed to receive a measurement sample for an examination by scanning probe microscopy; a measuring probe, which is received on a probe holder; a relocating device, which has a drive and is designed to relocate the sample receptacle and the probe holder having the measuring probe relative to each another by means of the drive for the examination by scanning probe microscopy; and an active counterweight device having a counterweight and a drive device associated with the counterweight, the active counterweight device being designed to move the counterweight during the measuring operation by means of the drive device, counter to the movement of the probe holder having the measuring probe. The invention furthermore relates to a method for operating the arrangement.

The invention relates to an arrangement having a measuring apparatus for a scanning probe microscope, to a scanning probe microscope, and to a method for operating an arrangement having a measuring apparatus for a scanning probe microscope, in particular an atomic force microscope.

### BACKGROUND

Such an atomic force microscope has an elastically flexible lever arm, at the end of which there is a measuring tip, as well as drives for the relative displacement between the measuring tip and a sample to be examined, wherein piezo actuators, for example, are used as drives in atomic force microscopy. Furthermore, a detection unit is provided for measuring the force on the lever arm which is also referred to as a cantilever. Depending on the design, the components are fixed to one or more holders. The movement of the drives can, if they perform a movement during measurement, for example a periodic oscillation movement, independently of their own resonance behavior, stimulate internal vibrations of the holder as a whole or of elements of the holder, which results in a falsified image of the surface or surface property of the sample. This is because the expected trajectory generated by the drives does not match the real relative movement between the measuring tip and the sample, which is made up of the sum of the internal vibrations of the holder and the trajectory generated by the drives.

### SUMMARY

The object of the invention is that of providing a measuring apparatus for a scanning probe microscope, a scanning probe microscope, and a method for operating a measuring apparatus for a scanning probe microscope, in all of which a disruptive influence from vibrations of a holding structure is reduced or completely avoided.

A scanning probe microscope, a scanning probe microscope, and a method for operating a measuring apparatus for a scanning probe microscope according to claims 1, 9 and 10 are provided for the solution. Embodiments are the subject of the dependent claims.

According to one aspect, an arrangement having a measuring apparatus is provided for a scanning probe microscope, which comprises the following: a sample receptacle which is configured to accommodate a measurement sample for an examination by scanning probe microscopy; a measuring probe which is accommodated on a probe holder; a displacement device which has a drive and is configured to displace the sample receptacle and the probe holder together with the measuring probe relative to one another by means of the drive for the examination by scanning probe microscopy; and an active counterweight device having a counter mass and a drive device associated with the counter mass, wherein the active counterweight device is configured to move the counter mass, by means of the drive device, in the opposite direction to the movement of the probe holder together with the measuring probe during the measurement operation.

According to a further aspect, a method for operating an arrangement having a measuring apparatus for a scanning probe microscope is provided, which comprises the following steps: providing a sample receptacle; arranging a measurement sample on the sample receptacle; and examining the measurement sample by means of scanning probe microscopy, wherein a measurement probe and the sample receptacle are displaced relative to one another by means of a displacement device which has a drive; and an interaction between the measuring probe and the measuring sample is detected by means of a detection unit. During the examination of the sample by scanning probe microscopy, a counter mass of an active counterweight device is actively moved in the opposite direction to the movement of the probe holder together with the measuring probe by means of a drive device associated with the counter mass.

According to a further aspect, a scanning probe microscope having the arrangement is provided.

The excitation of vibrations, which can be triggered by the movement of the drives of the displacement device during measurement, is reduced or completely avoided by means of the mass moved along with it, such that the actual relative movement between the measuring tip and the sample (sample holder) corresponds to the trajectory generated by the drives. This improves the measurement accuracy. The counter mass or counterweight is actively moved in the opposite direction, that is to say by means of the drive device associated with the counter mass, which can only be used to move the counter mass. The active counterweight device, which can also be referred to as an active counter mass device, can be arranged on a holder on which the drive of the displacement device is accommodated.

A holding device of the active counterweight device, on which the drive device of the active counterweight device is arranged, can be mounted on the holder.

A mass of the active counterweight device can have an aperture through which a condenser beam path can be formed.

The drive device of the active counterweight device can be configured to move the counterweight multidimensionally in the opposite direction to the movement of the measuring probe.

The counter mass can be substantially equal to a total mass of the probe holder and measuring probe. Alternatively, the counter mass can be substantially equal to a total mass of the detection unit, probe holder and measuring probe. In an alternative embodiment, the total mass can comprise the mass of an elastic lever arm on which the measuring probe is arranged, for example at a distal end with respect to the probe holder.

Further aspects are explained in more detail below.

An active counterweight device is provided, that is to say a device having a counterweight (mass) which is (actively) moved by means of an associated drive device. In one embodiment, the counterweight device can comprise the following: a mass and one or more drives that are connected to the mass such that the mass can be set in motion by means of the drive or drives. The movement takes place in the opposite direction to the movement of the probe holder together with the measuring probe.

The mass can be fixed to a holder in order to fasten it in turn to the holding device of the measuring apparatus. The at least one drive of the counterweight device can be connected, for example directly, to the holder of the measuring apparatus. The holder can have guide elements which stabilize the movement of the counterweight along a predetermined movement path, regardless of whether this is in one or more spatial directions.

The drives and/or the drive device can be formed with at least one piezo actuator. The drives and/or the drive device can be formed exclusively with piezo actuators.

The drives and the drive device can be formed with structurally identical drive modules, for example structurally identical piezo actuators.

In one embodiment, the mutually associated masses of the detection unit and the counterweight device are arranged substantially one above the other—that is, the axes perpendicular to each direction of movement through the centers of mass of the masses are close to one another.

In one embodiment, a measuring apparatus for a scanning probe microscope is provided which comprises the following: a sample receptacle which is configured to accommodate a measurement sample for an examination by a scanning probe microscope; a measuring probe; a displacement device which has a drive and is configured, by means of the drive, to displace the sample receptacle and the probe holder together with the measuring probe relative to one another for the examination by scanning probe microscopy; and an active counterweight device having a counterweight and a drive device associated with the counterweight, wherein the active counterweight device is configured to move the counterweight, by means of the drive device, in the opposite direction to the movement of the measuring probe during the measurement operation.

In one embodiment, a method for operating a measuring apparatus for a scanning probe microscope is provided, which comprises the following steps: providing a sample receptacle; arranging a measurement sample on the sample receptacle; and examining the measurement sample by means of scanning probe microscopy, wherein a measuring probe and the sample receptacle are displaced relative to one another by means of a displacement device which has a drive; and an interaction between the measuring probe and the measurement sample is detected by means of a detection unit. During the examination of the sample by scanning probe microscopy, a counterweight of an active counterweight device is actively moved in the opposite direction to the movement of the probe holder together with the measuring probe by means of a drive device associated with the counterweight.

In one embodiment, a control or drive signal, for example a voltage, which is sent during operation to the drive or drives for the relative displacement between the measuring probe and a sample holder having the sample to be examined, can also be sent (in parallel) to the drive device associated with the counter mass, wherein an adjustment can optionally be provided, for example to take into account different designs or types of the drives used in each case. If the control or drive signal for the drives is changed, the same adjustment is made for the drive device.

In one embodiment, vibrations can be detected for the holder by means of a sensor device, and control or drive signals for the drive device of the counter mass can be adjusted as a function of the detected sensor signals in order to further optimize the countermovement of the counter mass.

An actually executed movement during the relative displacement between the measuring probe and a sample holder having the sample to be examined can be detected by means of sensors and detected sensor signals can be taken into account when generating the control or drive signals for the drives. This then leads to the control or drive signals for the drive device of the counter mass being adjusted or regulated accordingly.

The embodiments provided in connection with the different embodiments of the arrangement, the measuring apparatus or the scanning probe microscope, which can be, for example, an atomic force microscope, can be provided accordingly in connection with the method for operation.

### DESCRIPTION OF THE EMBODIMENTS

In the following, further embodiments are explained with reference to figures of a drawing, in which:

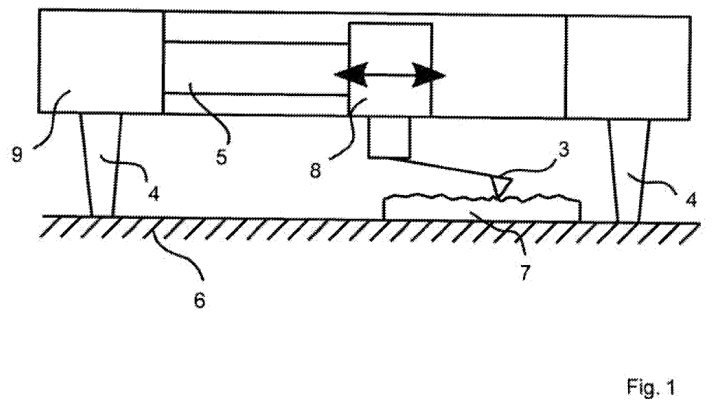

FIG. 1 is a schematic illustration of a construction of a measuring apparatus for a scanning probe microscope in the form of a measuring tip scanner according to the prior art;

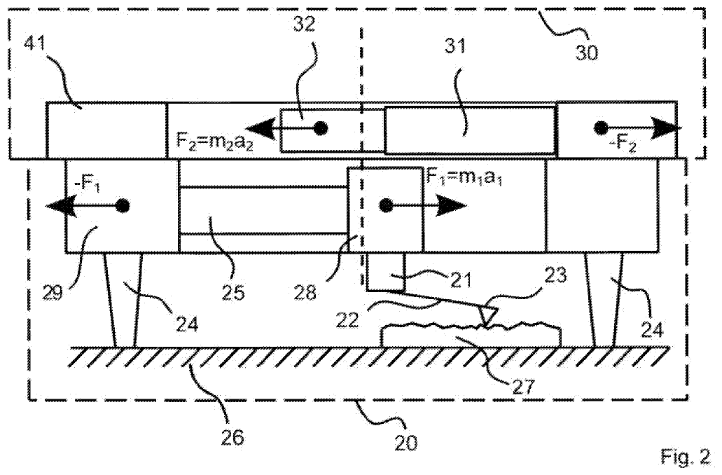

FIG. 2 is a schematic illustration of an arrangement for an atomic force microscope having a measuring apparatus in the form of a measuring tip scanner with which an active counterweight device is associated;

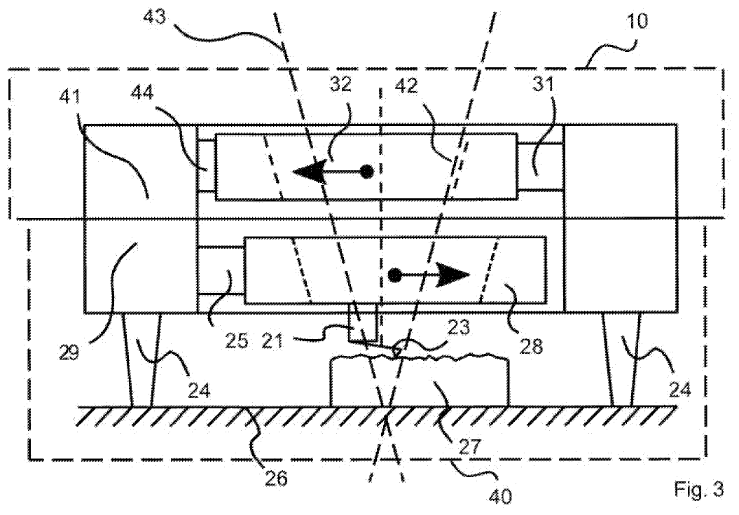

FIG. 3 is a schematic illustration of a further arrangement for an atomic force microscope having a measuring apparatus in the form of a measuring tip scanner with which an active counterweight device having a counter mass which has an aperture is associated;

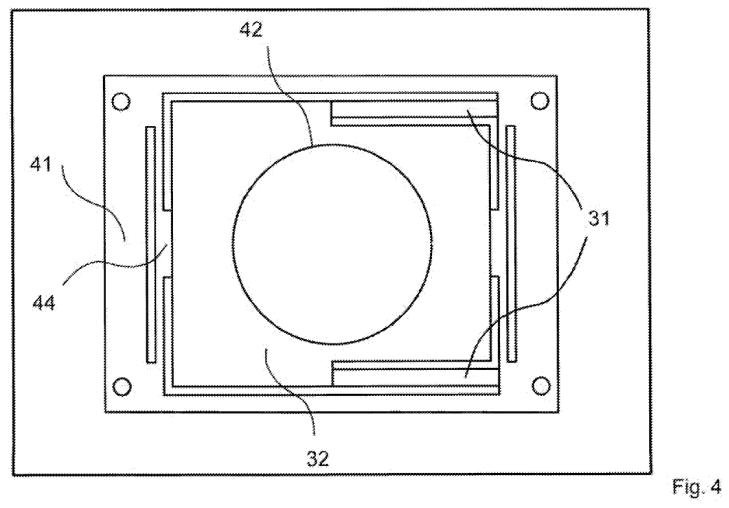

FIG. 4 is a planar illustration of the arrangement shown in FIG. 3, and

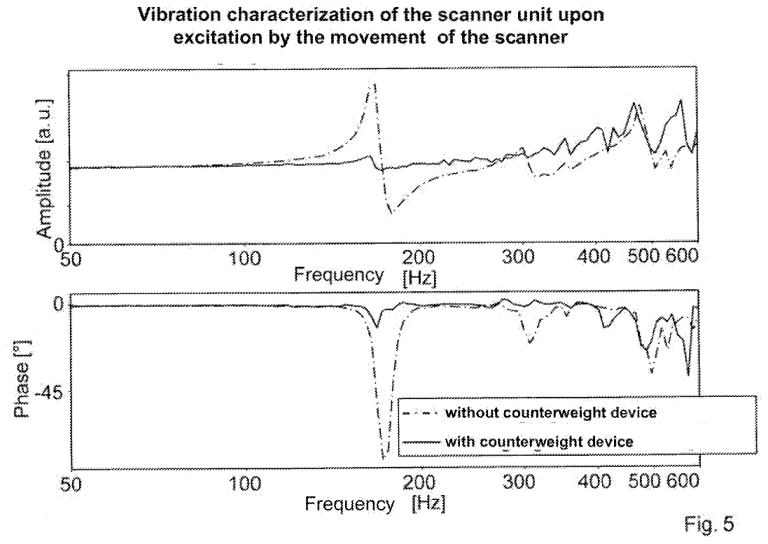

FIG. 5 shows a measured response function for a measuring probe of an atomic force microscope with and without active damping by means of an active counterweight.

A known measuring apparatus for an atomic force microscope according to the schematic illustration in FIG. 1 has an elastically flexible lever arm 2 on a probe holder 1, at the end of which lever arm there is a measuring probe 3 which is also referred to as a measuring tip. Drives 4, 5 are provided for the relative displacement between the measuring probe 3 and a sample receptacle 6 having a sample 7 to be examined. Furthermore, a detection unit 8 is provided for measuring the force on the lever arm 2 by means of the measuring probe 3. The parts or components are accommodated on a holder 9. The embodiment of the measuring apparatus for an atomic force microscope from FIG. 1, which is known per se, or at least subelements thereof, can be provided in the measuring apparatuses explained below.

FIG. 2 shows a schematic illustration of an arrangement for an atomic force microscope of a measuring apparatus 20 which, in the example shown, is formed with a measuring tip scanner. An elastically flexible lever arm 22 is accommodated on a probe holder 21, at the end of which a measuring probe 23 is arranged which is also referred to as a measuring tip. Drives 24, 25 are used during operation for the relative displacement between the measuring probe 23 and a sample receptacle 26 having a sample 27 to be examined, it being possible, for example, to use piezo actuators as drives. The measuring probe 23 is arranged on the probe holder 21 which can be equipped with a drive for the (further) displacement of the measuring probe 23 relative to the sample receptacle 26. A detection unit 28 is provided for measuring the force on the lever arm 22 by means of the measuring probe 23 when the measuring probe 23 is displaced relative to the sample 27 during the examination of the sample 27. The parts or components are accommodated on one or more holders 29, depending on the design.

The movement of the drives 24, 25 during the measurement operation can excite or cause internal vibrations of the holder 29, in particular of parts or elements of the holder 29, and of the drives 24, 25 themselves, for example when a periodic oscillating movement is performed. In known measuring apparatuses (cf. FIG. 1), this can result in a falsified image of the surface or surface properties of the sample 27, since the expected trajectory generated by the drives does not match the real relative movement between the measuring tip and the sample, which is the sum of the (internal) vibrations of the holder and the trajectory generated by the drives.

According to FIG. 2, the measuring apparatus 20 is associated with an active counterweight device 30 on the holder 29 in order to prevent the disadvantageous influence at least of the vibrations. The measuring apparatus 20 and the active counterweight device 30 form an arrangement for a scanning probe microscope. An alignment of the active counterweight device 30 is selected in such a manner that, during the measuring operation, an actuator 31 which forms a drive for the active counterweight device 30 provides or causes a movement of a counterweight 32 (counter mass) of the active counterweight device 30 in the opposite direction to the movement of the measuring probe 28 (the detection unit 28) generated by means of the drives (actuators) 24, 25.

In the embodiment shown, the counter mass 32 and the total mass of the detection unit 28, probe holder 21, lever arm 22 and measuring probe 23 are arranged substantially one above the other—that is, the axes perpendicular to the direction of movement through each of the centers of mass are close to one another. Active damping for the holder 29—that is, compensation for the forces acting on the holder 29—is achieved by means of a suitable trajectory (movement path) of the counter mass 32. The holder 29 ideally remains at rest. Forces act on the holder 29 due to the high accelerations of the drives 24, 25, and the active counterweight device 30 generates a corresponding counterforce, such that, overall, in the best case no force, but at least a reduced resultant force, acts on the holder 29.

When piezo actuators for the drives 24, 25 are used which have characteristics which are as identical as possible, and when the masses of the counter mass 32 of the active counterweight device 30 and the total mass of the detection unit 28 (with the probe holder 21, lever arm 22 and measuring probe 23) are balanced, an equilibrium of forces in the plane of movement can be achieved over the entire extension length of the piezo actuators, in spite of the existing hysteresis, by arranging them in opposite directions of extension with the same applied voltage. For the active counterweight device 30, an additional voltage supply and regulation, as well as an additional detection unit for determining the position and/or movement of the probe holder 21, can be partially or completely dispensed with.

When the counter mass 32 is adjusted to the total mass of the detection unit 28, probe holder 21, lever arm 22 and measuring probe 23, individual components, for example the mass of the lever arm 22 and the measuring probe 23, can optionally be disregarded due to the mass ratios.

FIGS. 3 and 4 show an illustration of a further arrangement for an atomic force microscope having a measuring apparatus 40 in the form of a measuring tip scanner. According to FIGS. 3 and 4, the active counterweight device 30 for the measuring apparatus 40 comprises the counter mass 32, the drive 31 which is connected to the counter mass 32, and a holder 41 which in turn is connected to the counter mass 32 via the drive 31 and is used for attachment to the measuring apparatus 40. An aperture or opening 42 is provided on the counter mass 32, for example with a passage which allows a condenser beam path 43 to be formed through the measuring apparatus 40.

When the measuring apparatus 30 is in operation, as shown in FIG. 2, the excitation of vibrations of the holder 29 by the movement of the detection unit 28 are suppressed by means of the counterforce produced by the active counterweight device 30. The holder 29 remains at rest, and the relative trajectory of the measuring tip 23 with respect to the sample 21 that is actually intended by the drives 24, 25 is achieved.

In the embodiment (see FIG. 3), the counter mass 32 of the active counterweight device 30 is adjusted to the total weight of the detection unit 28 (with the probe holder 21, lever arm 22 and measuring probe 23), and the drive 31 of the active counterweight device 30 is identical to the drives 24, 25 of the measuring apparatus 40. If the drive or drives 31 of the active counterweight device 30 and the drives 25 of the measuring apparatus 40 are operated in the same way and are accommodated in opposite directions on the holder 29, the forces acting on the holder 29 will balance each other out. In the exemplary case of choosing piezo actuators as drives, one and the same voltage can thus be used to generate the movements. The need for further regulation and separate voltage supply and/or additional electronic components, such as voltage amplifiers, and data processing for optimizing the movement of the counter mass 32 are eliminated.

The holder 41 of the active counterweight device 30 can be positioned on the holder 29 independently of any knowledge of an exact fixing surface of the drives 25. Knowledge of the direction of movement and a sufficiently rigid fixation on the holder 29 are sufficient. Furthermore, the holder 41 can additionally provide a guide 44 for the counter mass 32 of the active counterweight device 30, such that vibrations outside a desired spatial direction are avoided.

In one embodiment, a control or drive signal, for example a voltage, which is sent to the drive(s) 24, 25 during operation for the relative displacement between the measuring probe 23 and a sample receptacle 26 having the sample 27 to be examined is also sent (in parallel) to the drive device 31 associated with the counter mass 32. In this case, it is optionally possible to provide for an adjustment, for example to take into account different construction designs or types of the drives used in each case. If the control or drive signal for the drives 24, 25 is changed, the same adjustment is made for the drive device 31. If, for example, the voltage at the drives 24, 25 is adjusted for the operation on the basis of a control, the same voltage adjustment also takes place for the drive 31 of the counterweight 32 (parallel connection in the excitation voltage).

FIG. 5 shows a schematic illustration to show an advantage that is achieved by means of the active counterweight device 30 with regard to the vibration amplitude and phase measured by means of a laser Doppler vibrometer along the direction of movement of the detection unit 28, with and without the active counterweight device 30. With the active counterweight device 30, amplitude and phase are more constant over a significantly greater frequency range.

In one embodiment, a multidimensional movement of the counter mass 32 of the counterweight 30 can be provided.

The features disclosed in the above description, in the claims, and in the drawing can be important both individually and in any combination for the implementation of the various designs.

1. An arrangement having a measuring apparatus for a scanning probe microscope, comprising:
a sample receptacle which is configured to accommodate a measurement sample for an examination by scanning probe microscopy;
a measuring probe which is accommodated on a probe holder;
a displacement device which has a drive and is configured to displace, by means of the drive, the sample receptacle and the probe holder together with the measuring probe relative to one another for the examination by scanning probe microscopy; and
an active counterweight device having a counter mass and a drive device associated with the counter mass, wherein the active counterweight device is configured to move the counter mass, by means of the drive device, in the opposite direction to the movement of the probe holder together with the measuring probe during the measurement operation.

2. The arrangement according to claim 1, wherein the active counterweight device is arranged on a holder on which the drive of the displacement device is accommodated.

3. The arrangement according to claim 2, wherein a holding device of the active counterweight device, on which the drive device of the active counterweight device is arranged, is mounted on the holder.

4. The arrangement according to claim 1, wherein the counter mass of the active counterweight device has an aperture through which a condenser beam path can be formed.

5. The arrangement according to claim 1, wherein the drive device of the active counterweight device is configured to move the counter mass multidimensionally in the opposite direction to the movement of the probe holder together with the measuring probe.

6. The arrangement according to claim 1, wherein the counter mass is substantially equal to a total mass of the probe holder and measuring probe.

7. The arrangement according to claim 1, wherein at least one of the drives and/or the drive device are formed with at least one piezo actuator.

8. The arrangement according to claim 1, wherein the drives and the drive device are formed with identical drive modules.

9. A scanning probe microscope having an arrangement according to claim 1.

10. A method for operating an arrangement having a measuring apparatus for a scanning probe microscope, comprising the steps of:
providing a sample receptacle;
arranging a measurement sample on the sample receptacle; and
examining the measurement sample by means of scanning probe microscopy, wherein
a measuring probe which is accommodated on a probe holder and the sample receptacle are displaced relative to one another by means of a displacement device which has a drive; and
an interaction between the measuring probe and the measurement sample is detected by means of a detection unit;
wherein, during the examination of the sample by scanning probe microscopy, a counter mass of an active counterweight device is actively moved in the opposite direction to the movement of the probe holder together with the measuring probe by means of a drive device associated with the counter mass.
